(19) United States
(12) Patent Application Publication
(10) Pub. No.: US 2024/0390866 A1
(43) Pub. Date: Nov. 28, 2024

(54) AN ONSITE SYSTEM FOR PREPARING A FUMIGANT

(71) Applicant: Draslovka Services Pty Ltd, Melbourne, Victoria (AU)

(72) Inventors: Adam Trocha, Melbourne, Victoria (AU); John Crocitti, Melbourne, Victoria (AU); Kade McConville, Melbourne, Victoria (AU)

(21) Appl. No.: 18/685,774

(22) PCT Filed: Aug. 25, 2022
(86) PCT No.: PCT/AU2022/051038

§ 371 Date: Feb. 22, 2024

(30) Foreign Application Priority Data
Aug. 25, 2021 (AU) 2021221583

(51) Int. Cl. B01F 23/10; A01M 1/20; A23B 9/22; B01F 35/83; B01F 35/90; B01F 35/92; B01F 101/04; B05B 7/16; B05B 7/24; F24H 15/212; F24H 15/238

(52) U.S. Cl. CPC B01F 23/12; A01M 1/2077; A23B 9/22; B01F 35/833; B01F 35/92; B05B 7/16; B05B 7/24; F24H 15/212; F24H 15/238; B01F 2035/99; B01F 2101/04

(57) ABSTRACT

An onsite system for generating a fumigant for use with foodstuffs comprising: an active fumigant vaporizing station comprising: a first water heater; a heat exchanger connectable to the first water heater to receive heated water therefrom, the heat exchanger being configured to receive, heat and vaporise active liquid fumigant entering into the heat exchanger via a fumigant inlet; and a fumigant outlet connected to the plate heat exchanger for delivering a stream of vaporised fumigant; a liquid diluent vaporizing station comprising: a second water heater; a shell and tube heat exchanger connectable to the second water heater to receive heated water therefrom, the shell and tube heat exchanger being configured to receive, heat and vaporise the liquid diluent entering into the shell and tube heat exchanger via a mixing liquid inlet; and a mixing liquid outlet connected to the shell and tube heat exchanger for delivering the vaporised diluent; and a mixing unit configured to receive and mix the vaporised fumigant from the fumigant outlet and the vaporized diluent liquid from the diluent liquid outlet; mixing of the vaporised fumigant and vaporised mixing liquid to deliver a vaporised fumigant mixture; and a mixing and control means at the mixing unit for mixing the vaporised fumigant and diluent at, or substantially at, a predetermined mixing ratio.

### FIELD OF THE INVENTION

The present invention relates to an onsite system for preparing a fumigant mix for use in fumigating and improved efficiency in control of pests associated with stored foodstuffs and crops. In particular, the present invention relates to a system for preparing a fumigant onsite for effective use in control of pests associated with structures for storing agricultural crops such as a grain silo, buildings, containers, shipping vessels and like structures.

The invention has been developed primarily for use in improving efficacy of fumigant formulations onsite and improving efficiency of use of fumigants for controlling pests in containers, vessels, silos including general fumigation of stored food sources and will be described hereinafter with reference to this application. However, it will be appreciated that the invention is not limited to this particular field of use.

### BACKGROUND OF THE INVENTION

Agricultural crops and foodstuffs such as fruit, vegetables and grains are susceptible to pests, rodents, and other pathogens. To minimize the effect of pests, rodents, and other pathogens on agriculture, biosecurity measures such as fumigation of structures including containers, vessels and storage facilities is undertaken.

It is also desirable to protect stored foodstuffs from pests and disease. Historically, fumigation has comprised the use of bactericidal, insecticidal, nematocidal or fungicidal chemicals, to structures including containers, vessels and storage facilities and stored foodstuffs, to disinfect or control pests and pathogens.

A wide range of chemical compounds have been used for fumigation purposes including hydrogen cyanide, calcium cyanide, sulphur dioxide, phosphine, methyl bromide, ethylene bromide, ethylene dichloride, 1,3-dichloropropene, ethyl formate, methyl isocyanate, sulfuryl fluoride, formaldehyde, carbon tetrachloride, dichlorobenzene, chloropicrin. Each of these compounds has advantages and disadvantages including hazards from toxicity and flammability.

Insect control in stored grain in Australia, in particular in on-farm storages, relies heavily on phosphine and methyl bromide. The wide-scale, improper application of and excessive reliance on phosphine continues to threaten development of insect resistance, and methyl bromide is found to be toxic to humans and other animals at high concentrations and contributes to ozone depletion.

Alternative fumigant treatments are being sought and ethyl formate (EtF) has shown potential in this role, in particular for disinfestation of grain and fresh produce such as fruits and vegetables. EtF as an active constituent in CO₂ is currently used as a fumigant of dried fruit in Australia and elsewhere. EtF is an ester formed when ethanol reacts with formic acid. EtF is considered safer and more environmentally friendly than methyl bromide. EtF however is volatile and highly flammable in its liquid state, having a boiling point of 54.3 degrees C. and a low flash point.

Accepted practice for fumigation involves supply of cylinders containing a mixture of liquid agent and non-flammable gas under high pressure. However, liquid fumigant constituents need to be in a gaseous form for use as a fumigant to more efficiently diffuse throughout a fumigation space without damaging a stored food commodity.

Existing methods of applying liquid EtF as a fumigant require withdrawal of the EtF/carbon dioxide liquid mixture from a pressurized cylinder with a dip tube, and to evaporate the withdrawn liquid by means of an electric vaporizer unit.

A typical electric vaporizer unit works on the principle of a tube and shell heat exchanger having a series of coils submerged in an electronically heated oil bath. The liquid fumigant passes through the coils and by means of convection, the heated oil transfers heat to vaporize the liquid fumigant. Problems arise with such units due to the different specific heat capacities and different rates of expansion of liquid fumigant mixtures such as EtF and CO₂. In addition, this can lead to condensation of EtF in situ on surfaces of foodstuff. This is undesirable as residue can build up on the commodities, causing the presence of localised brown spots.

This effect is further exacerbated when short bursts of fumigant gas are delivered as the proportion of EtF in CO₂ can be difficult to sustain, resulting in gas streams having localized high concentrations of either component. The concentration of EtF in CO₂ may change depending on the extracted and/or remaining liquid in the cylinder. This could lead to a result where stored foodstuff is exposed to negative effects of higher concentrations of EtF as the cylinder of liquid fumigant empties and lead to inaccurate dosing and control of target pests.

Even further, this can result in low fumigant flow rates or fluctuating flow rates thereby requiring long treatment times with greater expense.

Current vaporizer units suffer from drawbacks including:
Use of oil requires frequent replacement and disposal of waste oil with concomitant environmental issues;
Fluctuation in temperature;
Difficulty in controlling vaporization;
Precipitation of liquid fumigant;
Localized high concentrations of liquid fumigant component contacting foodstuffs;
Require use of specialised electric heating elements with insufficient heat energy and associated high costs;
Large volume of oil is required;
Long lead time for achieving effective temperature for vaporization of liquid fumigant;
Low flow rates of fumigant gases hence time consuming and expensive.

The present invention seeks to provide a practical means to enable practical use of a fumigant, which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

The present invention in a first aspect is directed to an onsite system for preparing a fumigant formulation for fumigating containers and stored foodstuffs, comprising: a bulk source of an active liquid fumigant and a bulk source of a liquid diluent for the fumigant; a first vaporizing station for receiving and vaporizing a supply of the active liquid fumigant; a second vaporizing station interconnected to the first vaporizing station for vaporizing a supply of the liquid diluent; a mixing station fluidly connected to the first and second vaporization stations, the mixing station adapted to receive incoming streams of the vaporized fumigant and diluent, wherein the mixing station includes a vapor control means to mix the incoming fumigant and diluent vapor streams in a predetermined ratio for effective use in control of pests associated with structures for storing agricultural crops such as a grain silo, buildings, containers, shipping vessels and like structures

The onsite system for preparing a fumigant formulation overcomes the problem associated with vaporizing a premixed pressurized cylinder of fumigant in a liquid diluent which could otherwise lead to inaccurate dosing and control of target pests.

The present onsite system provides a consistent concentration of vaporized active fumigant hence minimizing the adverse effects of exposure of foodstuffs to varying and indeed higher than desirable concentration of fumigant. In addition, the present system does not require transport of multiple cylinders and vaporizers to a fumigation site and processing of high pressurized cylinder contents.

The first vaporizing station of the onsite system can include: a first fluid supply; a pump connected to the fluid supply for drawing fluid at an ambient temperature therefrom; a heater operably connectable to a portable energy source, the heater connected to the pump for receiving and heating a flow of incoming fluid from the pump; a heat exchanger connected to and downstream from the heater adapted to receive an inflow of fluid at an elevated temperature from the heater, the heat exchanger having: a fluid pathway for fluid flow between the heater and the fluid supply; and a fumigant pathway separate from the fluid pathway, extending between an inlet and an outlet in the heat exchanger for flow of a liquid fumigant therebetween; wherein the liquid fumigant vaporises as it flows within the fumigant pathway between the inlet and the outlet with exposure to heat from the fluid pathway, and spent fluid is received by the first fluid supply for substantially continuous operation; wherein the fumigant exits the outlet of the heat exchanger in a vaporised state at a predetermined fumigant flow rate in a substantially sustained delivery stream to the mixing station.

The second vaporizing station of the onsite system can include: a second fluid supply; a second pump connected to the second fluid supply for drawing fluid at an ambient temperature therefrom; a second heater operably connectable to a portable energy source, the second heater interconnected to the second pump for receiving and heating a flow of incoming fluid from the second pump; a second heat exchanger connected to and downstream from the second heater, wherein the second heat exchanger includes a fluid flow pathway to circulate the fluid between the second heater and second fluid supply; an inlet on the heat exchanger for receiving a supply of pressurized liquid diluent and an outlet interconnected to the mixing station.

The second fluid supply can be the first fluid supply. The fluid supply can be a supply of water. The mixing station can include a mixing control unit comprising one or more electronically controllable valves for predetermined flow of incoming vaporized fumigant and diluent.

In a related aspect of the present invention, there is described an onsite system for generating a fumigant for use with foodstuffs comprising: a fumigant vaporizing station comprising: a water supply; a first water pump connected to the water supply; a first water heater adapted to receive water from the water pump at an ambient temperature and predetermined flow rate; a heat exchanger interconnected to the first water heater to receive heated water therefrom; an inlet in the heat exchanger for receiving liquid fumigant from a bulk pressurized source, and an outlet for egress of vaporized fumigant, the outlet interconnected to a mixing station, the heat exchanger being configured to receive, heat and vaporise active liquid fumigant entering into the heat exchanger via a fumigant inlet; a liquid diluent vaporizing station interconnected to the fumigant vaporizing station comprising: a second water pump connected to the water supply of the fumigant vaporizing station; a second water heater connected to the second water pump for receiving circulated ambient water from the second pump; a second heat exchanger interconnected to the second water heater to receive heated water therefrom; an inlet on the heat exchanger for receiving a supply of liquid diluent from a bulk source of pressurized liquid diluent, and an outlet for egress of vaporized diluent; the shell and tube heat exchanger being configured to receive, heat and vaporise the liquid diluent entering into the shell and tube heat exchanger via a mixing liquid inlet; and a mixing liquid outlet connected to the shell and tube heat exchanger for delivering the vaporised diluent; and a mixing unit configured to receive and mix the vaporised fumigant from the fumigant outlet and the vaporized diluent liquid from the diluent liquid outlet; mixing of the vaporised fumigant and vaporised mixing liquid to deliver a vaporised fumigant mixture; and a mixing and control means at the mixing unit for mixing the vaporised fumigant and diluent at, or substantially at, a predetermined mixing ratio.

In a related aspect of the invention there is described an apparatus for vaporising a fumigant, for vaporising a mixing liquid, and for mixing the vaporised fumigant with the vaporised mixing liquid, the apparatus including: (i) a fumigant vaporiser comprising: a first water heater; a plate heat exchanger connectable to the first water heater to receive heated water therefrom, the plate heat exchanger being configured to receive, heat and vaporise the fumigant entering into the heat exchanger via a fumigant inlet; a fumigant outlet connected to the plate heat exchanger for delivering vaporised fumigant; (ii) a mixing liquid vaporiser interconnected to the fumigant vaporiser comprising: a second water heater; a second heat exchanger connectable to the second water heater to receive heated water therefrom, the shell and tube heat exchanger being configured to receive, heat and vaporise the mixing liquid entering into the shell and tube heat exchanger via a mixing liquid inlet; a mixing liquid outlet connected to the shell and tube heat exchanger for delivering the vaporised mixing liquid; and (iii) a mixing and control unit configured to receive and mix the vaporised fumigant from the fumigant outlet and the mixing liquid from the mixing liquid outlet and control the mixing of the vaporised fumigant and vaporised mixing liquid to deliver a vaporised fumigant mixture at, or substantially at, a predetermined mixing ratio effective for fumigation.

Preferably, the fumigant comprises Ethyl Formate. Preferably, the mixing fluid comprises liquid CO₂.

The second heat exchanger can be a shell and tube heat exchanger.

Preferably, the predetermined mixing ratio is controlled by the mixing station. The predetermined mixing ratio can vary between about 10% w/w to 20% w/w fumigant and about 80% w/w to about 90% w/w mixing liquid diluent. More preferably the predetermined mixing ratio comprises about 16.7% w/w fumigant and about 83.3% w/w mixing liquid diluent.

Preferably, the system is configured to deliver the vaporised fumigant mixture at or above a pre-determined vaporised fumigant mixture outflow rate. Preferably, the pre-determined vaporised fumigant mixture outflow rate is in a range between 3 kg/min and 8 kg/min. More preferably, the pre-determined vaporised fumigant mixture outflow rate is in a range between 5 kg/min and 7 kg/min. In one preferred embodiment, the pre-determined vaporised fumigant mixture outflow rate is about 6 kg/min.

Preferably, the heat exchanger for the fumigant is a plate heat exchanger which is configured to heat the fumigant to a temperature at or above a pre-determined fumigant vaporisation temperature. Preferably, the pre-determined fumigant vaporisation temperature is about 55 degrees Celsius.

Preferably, the first water heater is configured to heat the water therein to a temperature in a range between 60 degrees Celsius and 99 degrees Celsius. More preferably, the first water heater is configured to heat the water therein to a temperature in the range of about 80 degrees Celsius to 98 degrees Celsius. Preferably, the first water heater is configured to heat the water therein to a temperature in the range of about 90 degrees Celsius to 95 degrees Celsius. Most preferably, the first water heater is configured to heat the water therein to a temperature of about 95 degrees Celsius.

Preferably, the fumigant inlet is configured to receive the fumigant at or above a pre-determined fumigant inflow rate. Preferably, the pre-determined fumigant inflow rate is in a range between 0.5 kg/min and 7 kg/. More preferably, the pre-determined fumigant inflow rate is in a range between min 0.1 kg/min and 3 kg/min. Most preferably, the pre-determined fumigant inflow rate is about 1.0 kg/min to 1.5 kg/min.

Preferably, the mixing liquid inlet is configured to receive the mixing liquid at or above a pre-determined mixing liquid inflow rate.

Preferably, the first and second water heater comprises a gas powered water heater. Preferably, the gas-powered water heater is a tankless on demand type water heater.

Preferably, the system is configured to provide heated water to the plate heat exchanger and/or shell and tube heat exchanger at a temperature in the range of about 80 degrees Celsius to 98 degrees Celsius. More preferably, the system is configured to provide the heated water to the plate heat exchanger and/or shell and tube heat exchanger at a temperature in the range of about 90 degrees Celsius to 95 degrees Celsius. In a most preferred embodiment, the system is configured to provide the heated water to the plate heat exchanger and/or second heat exchanger at a temperature of about 95 degrees Celsius.

Preferably, the system is configured to circulate the water around: the plate heat exchanger and the first water heater; and/or the shell and tube heat exchanger and the second water heater. More preferably, the system is configured to circulate the water into the first water heater and/or second water heater at a temperature in the range of about 65 degrees Celsius to 85 degrees Celsius. The system is preferably configured to circulate the water into the first water heater and/or second water heater at a temperature in the range of about 70 degrees Celsius to 80 degrees Celsius, and most preferably the system is configured to circulate the water into the first water heater and/or second water heater at a temperature of about 75 degrees Celsius.

Preferably, the system is configured to maintain the water circulating around the plate heat exchanger and first water heater at or above a pre-determined water circulation temperature, and/or to maintain the water circulating around the shell and tube exchanger and second water heater at or above the pre-determined water circulation temperature. More preferably, the predetermined water circulation temperature is in the range of about 65 to 85 degrees. Most preferably, the predetermined water circulation temperature is in the range of about 70 to 80 degrees.

Preferably the system is configured to maintain the water circulating around the plate heat exchanger and first water heater at or above a pre-determined water circulation flow rate and/or to maintain the water circulating around the shell and tube exchanger and second water heater at or above the pre-determined water circulation flow rate. Preferably, the pre-determined water circulation flow rate is in the range of about 20 L/min to 60 L/min. More preferably, the pre-determined water circulation flow rate is in the range of about 35 L/min to 45 L/min and most preferably, the pre-determined water circulation flow rate is about 40 L/min.

Preferably, the system is configured to circulate water around the plate heat exchanger and first water heater using a water circulation device and/or to circulate water around the shell and tube heat exchanger and second water heater using a second water circulation device.

Preferably, the first or second water heater is connected to a respective first or second water vessel via a respective first or second water heater inlet.

Preferably, the apparatus is configured to circulate water around the plate heat exchanger, first water heater and first water vessel using the first water circulation device, and/or to circulate water around the shell and tube heat exchanger, second water heater and second water vessel using the second water circulation device.

Preferably, the respective first or second water circulation device comprises a respective first or second water pump configured to draw water from the respective first or second water vessel and pump it into the respective first or second water heater.

Preferably, the first or second pump is configured to pump the water at a flow rate of approximately 40 L/min.

Preferably, the mixing control unit and control unit comprises one or more electronically controllable valves. Preferably, the electronically controllable valves comprise one or more of, or any combination of: a) an electronically controllable globe valve; b) an electronically controllable gate valve; c) an electronically controllable ball valve; d) an electronic needle valve; e) an electronically controllable butterfly valve.

Preferably, the system includes one or more controllers for controlling one or more of the following: a) The temperature range in which water is heated by the first water heater; b) The temperature range in which water is heated by the second water heater; c) The temperature range in which the apparatus is able to provide heated water to the plate heat exchanger; d) The temperature range in which the apparatus is able to provide heated water to the shell and tube heat exchanger. e) the pre-determined vaporised fumigant outflow rate; f) the pre-determined fumigant inflow rate; g) the pre-determined mixing liquid inflow rate; h) the pre-determined water circulation temperature; i) the pre-determined water circulation flow rate; j) the one or more electronically controllable valves on the mixing and control unit.

Preferably, the system includes a frame, and the first water heater, first water heater inlet, plate heat exchanger, fumigant inlet and fumigant outlet are located on the frame.

Preferably, one or more of the following components are located on the frame: a) the water vessel; b) the water circulation device; c) piping for connecting the water vessel to the water circulation device; d) piping for connecting the water circulation device to the first water heater and/or first water heater inlet; e) piping for connecting the first water heater to the plate heat exchanger; f) piping for connecting the plate heat exchanger to the water vessel.

Preferably, the system includes a flow meter for measuring the liquid fumigant inflow rate.

Preferably, the apparatus includes a flow meter for measuring the diluent inflow rate. Preferably, the flow meter for measuring the mixing liquid flow rate comprises an EtF positive displacement flowmeter.

Preferably, the system includes a flow meter for measuring the vaporised fumigant outflow rate. Preferably, the system includes a flow meter for measuring the vaporised mixing liquid outflow rate. Preferably, the flow meter for measuring the vaporised mixing liquid outflow rate comprises a vortex flowmeter.

Benefits of the invention include:
The onsite system provides a consistent concentration of vaporized active fumigant hence minimizing the adverse effects of exposure of foodstuffs to varying and indeed higher than desirable concentration of fumigant;
Ability to use an alternative heat source such as LPG, contrary to prior art devices due to high flammability of liquid EtF, creates a larger available source of heat energy (roughly 59.0 KW) compared with the prior art electric vaporizer units which uses 2×240V 10 A plugs that combine to provide an available heat energy of 4.8 kW. In addition, as oil is heated it undergoes physical changes such as viscosity which further introduces an energy loss factor;
Consistent concentration of fumigant means less likelihood of pest resistance;
The present system does not require transport of multiple cylinders and vaporizers to a fumigation site and processing of cylinder contents;
Problems associated with high pressurized cylinders is overcome.

Other aspects of the invention are also disclosed with reference to accompanying examples.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is a schematic representation from one side of a in accordance with a preferred embodiment of the present invention;

FIG. 2 is a schematic representation of a system from front view in accordance with a preferred embodiment of the present invention.

### DESCRIPTION OF PREFERRED EMBODIMENTS

It should be noted in the following description that like or the same reference numerals in different embodiments denote the same or similar features.

Referring to the drawings there is shown an onsite system 1 for generating a fumigant mixture 2 from a source of liquid EtF fumigant active agent 3 and a liquid CO₂ diluent source 4 for use to eradicate pests from stored foodstuffs.

The system comprises a source of liquid EtF fumigant 3 and a source of a liquid CO₂ diluent 4 for the fumigant, which can be in bulk or select amounts depending on the size of application. There is shown a first vaporizing station 5 in fluid communication with a second vaporizing station 6, and a mixing station 7 receiving dual streams of vaporized EtF and CO₂ from respective vaporising stations.

The first vaporizing station is connected to a bulk source 3 of EtF adapted to receive and for vaporizing a supply of the active EtF liquid fumigant, and a second vaporizing station 6 connected to a bulk source 4 of liquid CO₂ adapted to receive and for vaporizing a supply of liquid diluent; and a mixing station 7 adapted to receive an incoming vaporized stream of fumigant 8 and a vaporized stream of CO₂ diluent 9.

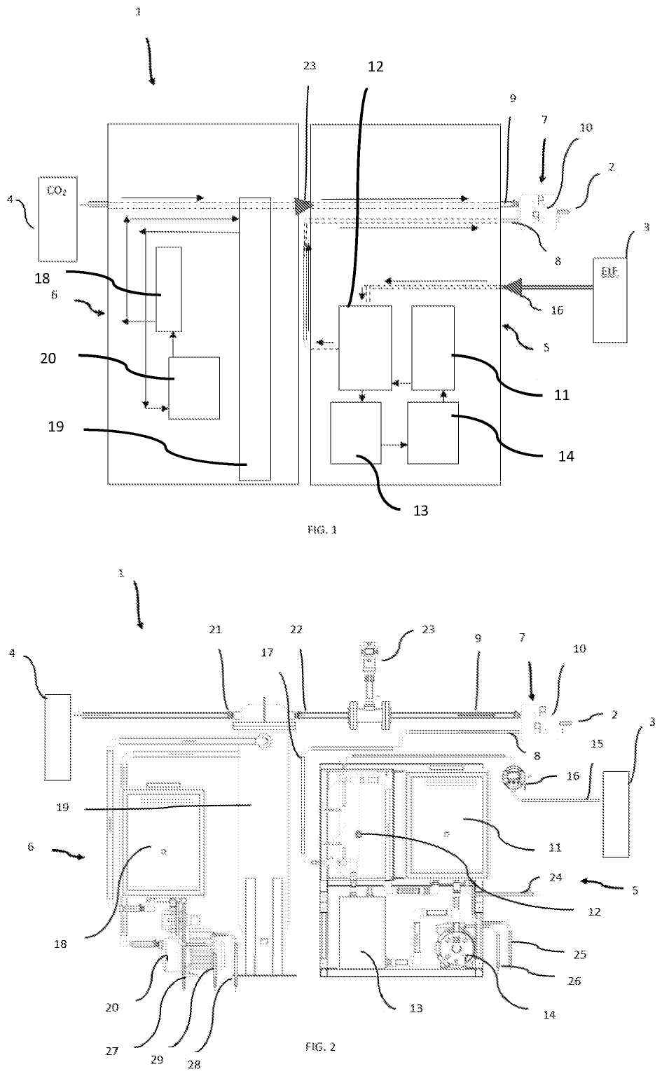

As shown in FIG. 1, the mixing station 7 includes a vapor control means 10 for mixing the incoming vapor streams in a predetermined ratio to prepare a fumigant vapor composition 2 effective fumigation of stored foodstuffs.

The first vaporizing station 5 includes a heat exchanger 12 being a plate heat exchanger which receives an incoming stream of liquid EtF at a predetermined flow rate of 2.5 kg/min controlled by a flow controller 16. The incoming EtF stream traverses a first pathway within the heat exchanger 12 and exits the heat exchanger in a vapor state moving towards the mixing station 7 at the flow rate of 2.5 Kg/min. The first vaporizing station 5 further includes a fluid circulation pathway between a fluid supply vessel 13, pump 14, heater 11 and the heat exchanger 12, whereby fluid from the fluid supply vessel is drawn by the pump 14 and pumped to the heater at a temperature of about 70 degrees C. and flow rate of 40 L/min. Fluid is heated by the heater and exits the heater to the heat exchanger at a temperature of about 95 degrees C. As the heated fluid passes through the plate heat exchanger 12, liquid EtF is vaporized and cooled fluid returned to the fluid supply vessel 13. Fluid is circulated through the first vaporizing station at a temperature of about 70 to 75 degrees C.

The second vaporizing station 6 includes a second heat exchanger 19 which can be a shell and tube exchanger that is substantially filled with water and includes: an inlet for receiving a stream of incoming liquid CO₂ from bulk source 4; an outlet for egress of vaporized CO₂; and a conduit therebetween defining a pathway for passage of CO₂ therethrough. The second vaporizing station 6 further includes a water pump 20 and a heater 18, whereby water is drawn from the heat exchanger 19 by the water pump 20 and transferred to the heater at a first temperature and flow rate.

Referring to FIG. 2, the onsite system of the invention is explained in more detail. In particular there is shown an onsite system 1 comprising a liquid fumigant vaporizing station 5 and a CO₂ liquid diluent vaporizing station 6. The liquid fumigant vaporizing station 5 comprises: a first water heater 11 powered by mains 240V 25 and connected to a gas supply 24; a plate heat exchanger 12 connectable to the first water heater 11; a water reservoir supply vessel 13 and a water pump 14 powered by mains supply 26 for drawing water from the reservoir 13 at a temperature of about 70 degrees C. and flow rate of about 40 L/min and urging through the water heater 11 for elevating the temperature to about 95 degrees C. The plate heat exchanger 12 receives the heated water from the water heater 11 and traverses a water flow pathway between an inlet and outlet, the spent water returned to the water supply vessel 13 hence water is recirculated between the heat exchanger 12 to the supply reservoir 13 of liquid fumigant vaporizing station 5. The liquid fumigant vaporizing station 5 is interconnected to an input feedline 15 from the bulk source 3 and drawn into the input feedline by a positive displacement flowmeter 16 at a predetermined flow rate.

In an operating condition, liquid EtF flows through the input feedline into the heat exchanger 12. The heat exchanger includes an internal pathway for flow of EtF and an exit line 17 to the mixing unit 7 via mixing inlet 8.

The liquid diluent vaporizing station 6 comprises: a second water heater 18 connected to a gas source 27 and powered by mains 28; a heat exchanger such as shell and tube heat exchanger 19 interconnected to the second water heater 18; a water pump 20 powered by mains 29 interconnected to the heat exchanger 19; wherein water from the heat exchanger 19 is drawn by the water pump 20 and flows into the second water heater 18 where the temperature of incoming water is raised to a predetermined temperature. Water flows out of the water heater and into the heat exchanger 19. As liquid CO₂ enters and flows through a liquid mixing diluent conduit within a top portion of the heat exchanger 19, the heat of the water vaporizes the liquid CO₂. As the liquid CO₂ vaporises, water cools and exits the heat exchanger by the pump recirculating through the water heater.

In operation, a predetermined supply of liquid CO₂ flows via a feedline 21 into the heat exchanger and vaporizes, and vaporized CO₂ exits the heat exchanger via mixing liquid outlet 22 to a CO₂ flow control meter 23 for delivering the vaporized CO₂ diluent to the mixing station at a predetermined flow rate.

The system 1 further includes a mixing unit 7 configured to receive and mix the vaporised fumigant from the fumigant outlet 8 and the vaporized diluent liquid from the diluent liquid outlet 9. The mixing unit 7 includes control valves 10 which control mixing of and maintain the incoming vaporized streams at, a predetermined mixing ratio for effective use as a fumigant.

### Benefits

The onsite system provides a consistent concentration of vaporized active fumigant hence minimizing the adverse effects of exposure of foodstuffs to varying and indeed higher than desirable concentration of fumigant;
Ability to use an alternative heat source such as LPG, contrary to prior art devices due to high flammability of liquid EtF, creates a larger available source of heat energy (roughly 59.0 KW) compared with the prior art electric vaporizer units which uses 2×240V 10 A plugs that combine to provide an available heat energy of 4.8 kW;
Takes significantly less time to vaporize constituents of the fumigant mix than conventional systems;
Overcomes dual loss of efficiency of prior art which uses electrical elements as a heat source and oil as a heating fluid;
Consistent concentration of fumigant means less likelihood of pest resistance;
The present system does not require transport of multiple cylinders and vaporizers to a fumigation site and processing of cylinder contents;
Problems associated with high pressurized cylinders is overcome.

### Interpretation

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### SCOPE OF INVENTION

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to onsite system for generating a fumigant using liquid sources of EtF and CO₂ diluent.

1-31. (canceled)

32. An onsite system for preparing a fumigant formulation for fumigating stored foodstuffs, comprising:
a source of an active liquid fumigant and a source of a liquid diluent for the fumigant;
a first vaporizing station for receiving and vaporizing a supply of the active liquid fumigant;
a second vaporizing station interconnected to the first vaporizing station for vaporizing a supply of mixing liquid diluent; and
a mixing station fluidly connected to the first and second vaporization stations, the mixing station adapted to receive a vaporized stream of fumigant and mixing liquid diluent to produce a vaporized fumigant mixture, wherein the mixing station includes a vapor control means to mix the vapor streams in a predetermined mixing ratio for gaseous fumigation of stored foodstuffs.

33. The system according to claim 32, wherein the first vaporizing station includes:
a first water heater;
a heat exchanger connectable to the first water heater to receive heated water therefrom, the plate heat exchanger being configured to receive, heat and vaporise the fumigant entering into the heat exchanger via a fumigant inlet; and
a fumigant outlet connected to the heat exchanger for delivering vaporised fumigant to the mixing station.

34. The system according to claim 32, wherein the second vaporizing station includes:
a second water heater;
a heat exchanger connectable to the second water heater to receive heated water therefrom, the heat exchanger being configured to receive, heat and vaporise the mixing liquid entering into the heat exchanger via a mixing liquid inlet; and
a mixing liquid outlet connected to the heat exchanger for delivering the vaporised mixing liquid to the mixing station.

35. The system according to claim 32, wherein the fumigant comprises Ethyl Formate and preferably, the mixing liquid comprises liquid CO₂.

36. The system according to claim 32, wherein the predetermined mixing ratio is controlled by the mixing station and varies between about 10% w/w to 20% w/w fumigant and about 80% w/w to about 90% w/w mixing liquid diluent.

37. The system according to claim 32, wherein the system is configured to deliver the vaporised fumigant mixture at or above a pre-determined vaporised fumigant mixture outflow rate which is preferably in a range between 3 kg/min and 8 kg/min, more preferably the pre-determined vaporised fumigant mixture outflow rate is in a range between 5 kg/min and 7 kg/min.

38. The system according to claim 33, wherein the heat exchanger for the first vaporizing station is a plate heat exchanger which is configured to heat the fumigant to a temperature at or above a pre-determined fumigant vaporisation temperature.

39. The system according to claim 33, wherein the first water heater is configured to heat the water therein to a temperature in a range between 60 degrees Celsius and 99 degrees Celsius.

40. The system according to claim 33, wherein the fumigant inlet is configured to receive the fumigant at or above a pre-determined fumigant inflow rate in a range between 0.5 kg/min and 7 kg/min.

41. The system according to claim 34, wherein the mixing liquid inlet is configured to receive the mixing liquid at or above a pre-determined mixing liquid inflow rate.

42. The system according to claim 33, wherein the system is configured to provide heated water to the plate heat exchanger and/or shell and tube heat exchanger at a temperature in the range of about 80 degrees Celsius to 98 degrees Celsius.

43. The system according to claim 33, wherein the system is configured to circulate the water around: the plate heat exchanger and the first water heater; and/or the shell and tube heat exchanger and the second water heater.

44. The system according to claim 33, wherein the system is configured to circulate water around the plate heat exchanger and first water heater using a water circulation device and/or to circulate water around the shell and tube heat exchanger and second water heater using a second water circulation device.

45. The system according to claim 33, wherein the first or second water heater is connected to a respective first or second water vessel via a respective first or second water heater inlet.

46. The system according to claim 33, wherein the apparatus is configured to circulate water around the plate heat exchanger, first water heater and first water vessel using the first water circulation device, and/or to circulate water around the shell and tube heat exchanger, second water heater and second water vessel using the second water circulation device.

47. The system according to claim 33, wherein the respective first or second water circulation device comprises a respective first or second pump configured to draw water from the respective first or second water vessel and pump it into the respective first or second water heater.

48. The system according to claim 32, wherein the first or second pump is configured to pump the water at a flow rate of approximately 40 L/min.

49. The system according to claim 32, wherein the mixing control unit and control unit comprises one or more electronically controllable valves comprising one or more of, or any combination of: a) an electronically controllable globe valve; b) an electronically controllable gate valve; c) an electronically controllable ball valve; d) an electronic needle valve; e) an electronically controllable butterfly valve.

50. The system according to claim 32, wherein the system includes one or more controllers for controlling one or more of the following: a) The temperature range in which water is heated by the first water heater; b) The temperature range in which water is heated by the second water heater; c) The temperature range in which the apparatus is able to provide heated water to the plate heat exchanger; d) The temperature range in which the apparatus is able to provide heated water to the shell and tube heat exchanger, e) the pre-determined vaporised fumigant outflow rate; f) the pre-determined fumigant inflow rate; g) the pre-determined mixing liquid inflow rate; h) the pre-determined water circulation temperature; i) the pre-determined water circulation flow rate; j) the one or more electronically controllable valves on the mixing and control unit.

51. The system according to claim 32, wherein the system includes a frame, and the first water heater, first water heater inlet, plate heat exchanger, fumigant inlet and fumigant outlet are located on the frame.
